(19) United States
(12) Patent Application Publication
(10) Pub. No.: US 2017/0182630 A1
(43) Pub. Date: Jun. 29, 2017

(54) Fine Machining Method and Machine Tool Unit

(71) Applicant: Mauser-Werke Obergndorf Maschinenbau GmbH, Oberndorf am Neckar (DE)

(72) Inventors: Wolfgang Römpp, Hardt (DE); Siegfried Gruhler, Vöhringen (DE)

(21) Appl. No.: 15/313,891

(22) PCT Filed: May 26, 2015
(86) PCT No.: PCT/EP2015/061578

§ 371 Date: Nov. 23, 2016

(30) Foreign Application Priority Data
May 27, 2014 (DE) 10 2014 107 461.0

(51) Int. Cl. B24B 39/02; B23B 41/16; B23Q 17/24

(52) U.S. Cl. CPC B24B 39/023; B23Q 17/2471; B23B 41/16; B23B 2260/004

(57) ABSTRACT

The invention relates to a method for fine-machining a bore of a plurality of workpieces and a machine tool unit. According to said method, the workpieces are subjected to fine-hole drilling and precision finishing, preferably roller-burnishing or smoothing, a post-processing measurement is carried out and, depending on said measurement, the fine-hole drilling tool is adjusted.

### BACKGROUND OF THE INVENTION

Field of the Invention

The invention relates to a method of fine-machining bores of a plurality of workpieces in accordance with the preamble of claim 1 and a machine tool unit for carrying out this method.

Description of Related Art

When precision-machining bores or bushings of a workpiece the actual drilling is frequently followed by fine-machining by fine-bore drilling and precision finishing by smoothing or roller-burnishing. For fine-bore drilling fine-bore drilling heads are used, as they are described in AT 404 001 B, for example. Smoothing may be carried out by means of a smoothing tool as disclosed in DE 10 2007 017 800 A1. Such smoothing tool has a convex smoothing body for smoothing the surface to be machined, i.e. the circumferential wall of the bore or bushing, by forming.

Alternatively, for precision finishing a roller-burnishing tool may be employed, as it is disclosed in WO 2012/107582, for example. In such roller-burnishing tool a rotatably supported ball is pressed against the circumferential surface to be machined in a preferably hydrostatic manner so that the latter is machined by forming.

After fine-bore drilling the machined surface still exhibits certain roughness which is defined, inter alia, by the cutting edge geometry, the feed and the speed of the fine-bore drilling tool. During subsequent roller-burnishing—to put it bluntly—the “hills” formed by the roughness are formed in the direction of the valleys so that, on the one hand, the roughness decreases and, on the other hand, the diameter is somewhat widened.

In the previously known methods after pre-finishing by fine-bore drilling the bore diameter is measured. In the case in which the diameter of the fine-machined bore is not within the given tolerance, the cutting edge of the fine-bore drilling tool will be appropriately corrected. In order to increase precision such correction may be made not before plural measured workpieces have been analyzed, with a trend being established from these measuring results and the cutting edge being appropriately corrected.

It is a problem with this procedure that the diameter expansion during roller-burnishing is also dependent, inter alia, on the roughness after fine-bore drilling. For example, upon wear of the cutting edge the roughness is increased so that the diameter expansion during roller-burnishing is accordingly increased. In addition, the dimensional stability during roller-burnishing itself is somewhat uncertain, which is within the range of microns, however—this uncertainty has to be taken into account during pre-boring by providing an appropriate tolerance.

As stated in the foregoing, upon wear of the cutting edge of the fine-boring tool thus the surface structure and consequently the expansion resulting from roller-burnishing will vary. This may entail the bore to have a diameter lying outside the tolerance after precision finishing (smoothing, roller-burnishing), although the measurement after fine-bore drilling showed a result lying within the tolerance range of fine-bore drilling. It is a particular problem in this context that feeding of the roller-burnishing tool is not possible or only possible with great difficulties, as the forming operation is substantially determined by the hydrostatic pressure by which the ball or balls are pressed against the circumferential surface to be machined.

A measuring method in which a measuring operation is carried out between the individual fine-machining steps, in the concrete case a fine-bore drilling step and a honing step, is disclosed in WO 2008/009411 A1.

### SUMMARY OF THE INVENTION

Compared to this, the object underlying the invention is to provide a method for fine-machining bores and a machine tool unit for carrying out this method by which the surface quality of the bore is improved with little effort.

In the method according to the invention for fine-machining bores of a plurality of workpieces at first fine-hole drilling of a bore of a first workpiece is carried out by means of a fine-hole drilling tool/fine-hole drilling head. After that, the bore is precision-finished (smoothed or roller-burnished) by means of a smoothing or roller-burnishing tool. As late as following precision-finishing, a measurement is carried out for checking the dimensional stability of the bore of the workpiece. In the case that the measurement is not within the given tolerance range, the tool adjustment of the fine-hole drilling head is corrected before the next workpiece will be machined. That is to say, in this post-processing measurement the fine-hole drilling head is adjusted depending on the measuring result after precision finishing—hence the manufacturing philosophy described in the beginning in which measurement takes place after each individual step is rejected. Precision finishing is understood to be preferably machining by forming, for example by smoothing or roller-burnishing.

It turned out that by the strategy according to the invention the surface quality can be kept on a high level within narrow limits throughout the entire manufacturing process so that the variations in roughness described in the beginning will not occur.

In an embodiment of the invention it is provided to carry out also an optical inspection of the workpiece in addition to measuring. Said optical inspection is preferably carried out equally after precision finishing, preferably after smoothing/roller-burnishing and prior to machining the next workpiece.

The machined workpiece may be a connecting rod, a crankcase or a bushing of a workpiece.

The tool of the fine-hole drilling head is adjusted taking the expanding dimension during smoothing and roller-burnishing into account.

In an embodiment of the invention precision finishing is preferably carried out by roller-burnishing.

A variant of the invention provides to carry out a measurement, in addition to the measurement after precision finishing, within the period prior to precision finishing and after fine-hole drilling and then to appropriately compensate the fine-hole drilling cutting edge. Accordingly, this is performed without any main time load.

The manufacturing quality can be further improved, when after precision finishing or between fine-hole drilling and precision finishing the surface quality of the bore is detected by a measuring means. Accordingly, parameters characterizing the surface quality, such as the roughness Ra or Rz, are established, wherein these results may equally be included in the correction of the cutting edge. In this way inaccuracies may be avoided which—as afore-described—are resulting from different diameter expansions with different degrees of roughness of the fine-hole drilled bore.

The measuring accuracy may be further improved, when in the measuring step for checking the dimensional stability of the bore a measuring means is employed which does not only detect the diameter of the bore but also the axial and radial deviations thereof from the predetermined bore shape and, resp., from the predetermined target dimension. In this way, the exact contour of the bore after fine-hole drilling can be detected and possible undesired inaccuracies such as ovality or a trumpet-like shape can be compensated by appropriately controlling the fine-hole drilling tool. For this purpose a piezo fine-hole drilling head by which such dimensional deviations may be compensated during fine-hole drilling is especially suited. Such piezo fine-hole drilling head is shown, for example, in WO 2013/011072 A2.

The machine tool unit for carrying out the method accordingly comprises a fine-bore drilling means, a precision finishing means and an integrated and/or external measuring station for measuring the workpiece. The control of the machine tool unit is designed so that the fine-hole drilling means is adjustable in response to the measuring result of the measuring unit.

Of preference, the control is configured so that the fine-hole drilling tool is adjusted also depending on the expanding dimension during smoothing.

The machine tool unit according to the invention may be designed to include a measuring unit which enables the surface quality, e.g. the roughness parameters such as Rz, Ra, Wt etc., to be detected. Then the cutting edge can be additionally compensated in response to said detected surface quality.

The measuring means for measuring the bore diameter may be configured so that not only the mean bore diameter but also radial as well as axial deviations from the ideal cylinder shape are detected. Said measuring means may be, for example, a measuring mandrel including a plurality of measuring points distributed in the radial and axial directions which allow for instance an inductive measurement of the respective area.

The control unit of the machine tool unit may accordingly also be designed for incorporating the results of the afore-mentioned measuring means (surface quality or bore geometry) in the control of the fine-hole drilling tool. In so doing, for example the cutting edge can be compensated, but it is also imaginable to vary the feed or the speed of the fine-hole drilling tool so as to adjust the desired surface quality and/or to ensure the dimensional stability of the bore.

The machine tool unit is preferably configured as an inverse-type machine as described in WO 2013/038007 A2.

These and other features and advantages of the invention will become apparent to those skilled in the art from the following description and the accompanying drawing. It should be understood, however, that the detailed description and specific examples, while indicating a preferred embodiment of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred embodiments of the invention will be illustrated in detail hereinafter by way of schematic drawings, in which:

FIG. 1 shows a schematic diagram of the method steps for fine-hole drilling a bore;

FIG. 2 shows a variant of the method according to FIG. 1 and

FIGS. 3, 4 show views of an inverse-type machine tool comprising a measuring station.

### DETAILED DESCRIPTION OF THE PREFERRED EMBODIMENTS

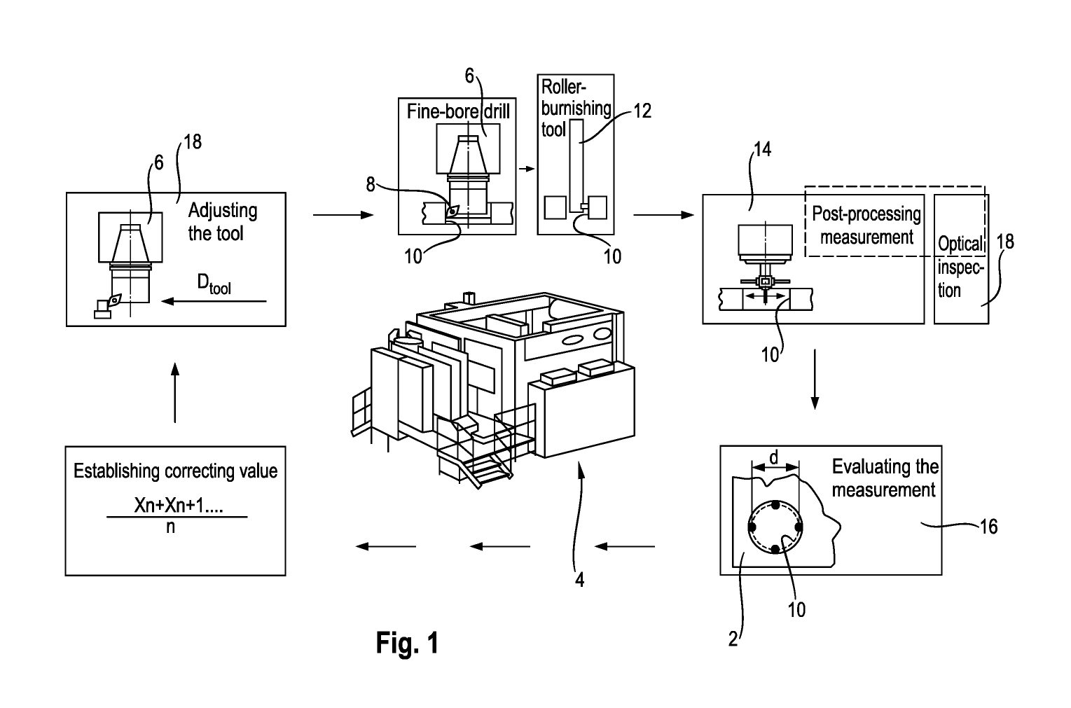

FIG. 1 shows a diagram for illustrating the method according to the invention for fine-machining bores of a plurality of workpieces, for example a crankcase 2. In the center a machine tool unit is represented which is in the form of an inverse-type machine 4. In a machine tool according to the inverse concept the workpiece is guided toward the workpieces supported on the machine frame. The inverse-type machine 4 includes at least one fine-hole drilling head 6 or any other tool suited for fine machining the cutting edge 8 of which is preferably adjustable in the radial direction for fine-hole drilling the bore 10 of the crankcase 2. Said bore 10 was machined before according to a conventional machining method, for instance by drilling. The inverse-type machine 4 is moreover configured to include a centering station (not shown) via which the workpiece 2 is centered prior to machining.

The inverse-type machine 4 further includes a roller-burnishing tool 12 for precision finishing the fine-hole drilled circumferential surface of the bore 10. The inverse-type machine 4 may basically be designed to have plural fine-bore drilling heads and roller-burnishing tools so that, accordingly, a plurality of workpieces can be simultaneously machined.

After precision finishing the circumferential surface of the bore by means of the roller-burnishing tool 12 the workpiece 22 is fed to a measuring station 14 (post-processing measurement). Said measuring station 14 is designed to have measuring means for measuring the dimensional stability of the bore 10. Furthermore, the measuring station 14 is designed to include an evaluating unit 16 (measuring computer) in which the measuring values are processed. As indicated in FIG. 1, the measuring station 14 may additionally be designed to further include a station 18 for optical inspection of the workpiece and, resp., of the bore 10. The transport between the individual stations is fully automated, for example via appropriate handling systems or robot arms.

The measuring values established via the evaluating unit 16 are compared to the predetermined target values of the workpiece geometry. In case that the measuring values deviate from the target values, a correcting value will be established via the evaluating unit 16 and then correspondingly via a machine control the fine-hole drilling tool 6 is adjusted depending on the correcting value and the next workpiece or a predetermined number of workpieces is/are machined with such tool setting. This workpiece or the next workpiece to be machined after machining the predetermined number of workpieces then will be measured in the afore-described manner again and, where necessary, the tool will be adjusted depending on the measuring values.

Accordingly, the cutting edge is corrected after fine-hole drilling and precision finishing on the basis of the data established during post-processing measurement. The fine-hole drilling tool is adjusted depending on the expansion of the bore formed during precision finishing. Such expanding dimension is taken into account in the correction cycle, wherein the diameter is intended to be maintained after fine-hole drilling within the upper limit of the tolerance window so that during roller-burnishing less material has to be formed.

In the process shown in FIG. 1 the station 18 for optical inspection is integrated in the machine concept.

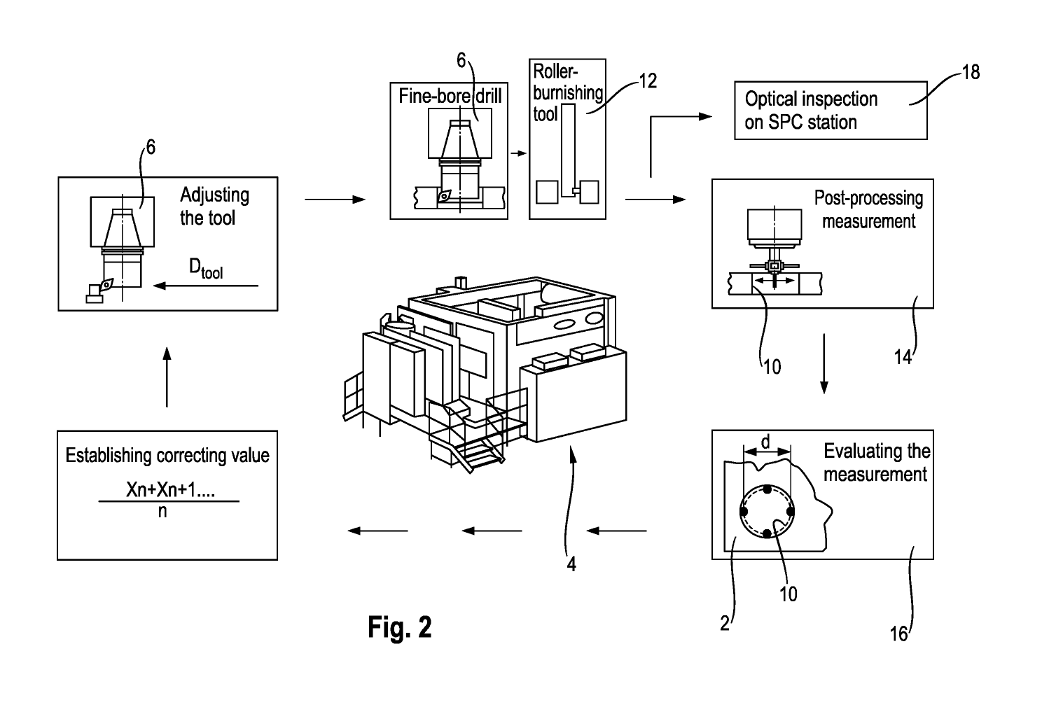

FIG. 2 illustrates a variant in which the station 18 for optical inspection is implemented on a separate SPC measuring station which is not integrated in the inverse-type machine. Otherwise the procedure according to FIG. 2 corresponds to the one shown in FIG. 1 so that further explanations on FIG. 2 may be dispensed with.

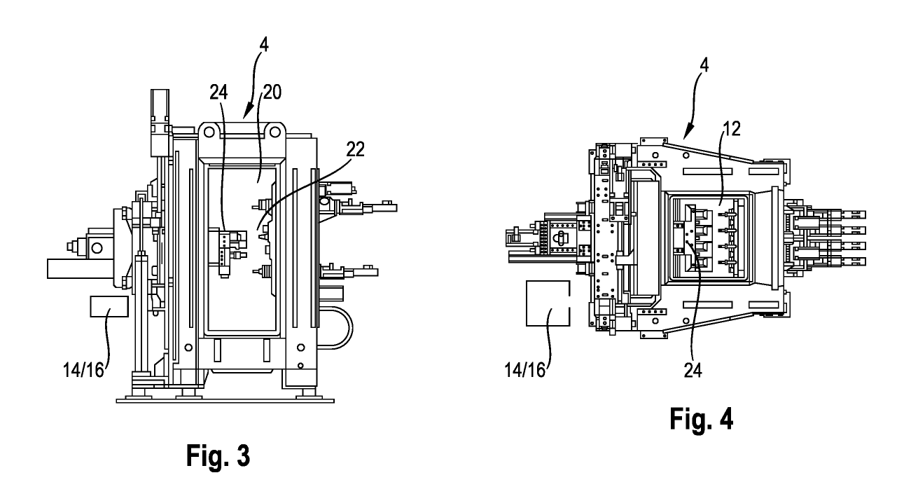

FIGS. 3 and 4 illustrate a lateral view and, resp., a top view of a machine tool designed according to the concept of the invention. It is an inverse-type machine 4 and in the broadest sense includes a box-shaped frame which spans a working space 20. On the fields confined by the frame braces on the one hand a plurality of tools 22 such as the fine-hole drilling tool 6 and the roller-burnishing tool 12, for example, are arranged. The workpieces are disposed on a workpiece holder 24 movable at least in the X and Y directions which may additionally be designed to further include at least one axis of rotation.

The measuring unit 14 and the associated evaluating unit 16 (measuring computer) are integrated in the machine concept and are in signal communication via a module common to the measuring unit and the machine tool. As afore-explained, at least stations for centering, fine-hole drilling, roller-burnishing and measuring are provided on the inverse-type machine 4. As a matter of course, also tools 22 for other machining steps may be provided. The workpieces are fed to and removed from the inverse-type machine 4 automatically.

As regards further details concerning the structure of such inverse-type machine, the state of the art described in the beginning is referred to.

Instead of the roller-burnishing tool also a different suited tool for precision finishing the bore, for example a smoothing tool in accordance with DE 10 2007 017 800 A1, may be employed, of course.

As explained in the beginning, via a further measuring means (not shown) the surface quality of the bore can be detected immediately after fine-bore drilling or after precision finishing (preferably roller-burnishing) and after that the control of the fine-hole drilling head can be appropriately influenced depending on the respective measuring result—for example after establishing a trend—. For example, cutting edge compensation (cutting edge adjustment) may be carried out. It is basically also imaginable to vary the feed and/or the speed so as to maintain the predetermined surface quality. The surface quality may be represented, for example, by the roughness parameters Ra, Rz, Wt etc.

Alternatively or additionally the measuring means may be configured so that the geometry of the bore is exactly detected both in the axial direction and in the radial direction.

For this purpose, a measuring mandrel may be employed which has plural measuring points both in the radial direction and in the axial direction so that ovalities, a trumpet shape or any other deviations from the ideal cylinder shape can be detected. Said deviations then can be compensated during fine-hole drilling by appropriately controlling the fine-bore drilling head, especially a piezo fine-bore drilling head.

This measuring means, for example the measuring probe, may be part of the integrated or external measuring unit for measuring the workpiece.

As explained in the beginning, in addition to the post-processing measurement after precision finishing also a measurement can be carried out in the period before precision finishing and after fine-hole drilling and then the fine-bore drilling cutting edge can be compensated depending on said measurements. It is a substantial advantage of the solution according to the invention that the measurement is carried out without any peak time load so that the workpiece can be machined with high efficiency.

The invention discloses a method for fine-machining a bore of a plurality of workpieces and a machine tool unit in which after subjecting the workpieces to fine-hole drilling and precision finishing, preferably roller-burnishing or smoothing, a post-processing measurement is carried out and, depending on said measurement, the fine-hole drilling tool is adjusted.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

1. A method for fine-machining bores of a plurality of workpieces comprising the steps of:
fine-bore drilling of a bore of a first workpiece by means of a fine-bore drilling head, precision finishing of the bore preferably by means of a smoothing or roller-burnishing tool and comprising a measuring step for testing the dimensional stability of the bore of a first workpiece and appropriate machining of the bores of at least one further workpiece, wherein the measurement is carried out after precision finishing of the bore of the first workpiece, and further comprising correcting a tool adjustment of the fine-bore drilling head on a result of the measuring step after precision finishing.

2. The method according to claim 1, comprising an additional optical inspection of the first workpiece after precision finishing and prior to machining a next workpiece.

3. The method according to claim 1, wherein the workpiece is a connecting rod, a crankcase or a bushing.

4. The method according to claim 1, wherein the tool adjustment of the fine-bore drilling head is made also depending on the expanding dimension during precision finishing.

5. The method according to claim 1, wherein the precision finishing is carried out by roller-burnishing or smoothing.

6. The method according to claim 1, wherein another measurement is carried out in the period after fine-bore drilling and before precision finishing of the bore.

7. The method according to claim 6, wherein, after fine-bore drilling and roller-burnishing parameters expressing surface quality are measured, the correction is made depending on the measuring parameters.

8. The method according to claim 1, wherein for the measuring step for testing the dimensional stability of the bore a measuring means is used by which axial and radial deviations of the bore from a target dimension or a target geometry are detected and the fine-bore drilling tool is controlled depending on said deviations.

9. A machine tool unit comprising a centering means, a fine-bore drilling means, a means for precision finishing and an integrated or external measuring unit for measuring the workpiece and a control which is designed for the fine-bore drilling means to be adjustable depending on the measuring result of said post-processing measurement.

10. The machine tool unit according to claim 9, wherein the control is designed to adjust the fine-bore drilling means depending on the expanding dimension during precision finishing.

11. The machine tool unit according to claim 9, wherein the means for precision finishing includes a roller-burnishing tool.

12. The machine tool unit according to claim 9, wherein the unit is an inverse-type machine.

13. The machine tool unit according to claim 9, further comprising a measuring means for detecting the surface quality and/or a measuring means for detecting axial and radial deviations of the bore from a target value.

14. The method according to claim 7, wherein the roller-burnishing parameters expressing surface quality include roughness (Ra, Rz, Wt).
